(19) United States
(12) Patent Application Publication
(10) Pub. No.: US 2008/0310948 A1
(43) Pub. Date: Dec. 18, 2008

(54) MATERIAL MOVING DEVICE AND METHOD

(75) Inventors: ARDEN L. BORGEN, Des Moines, IA (US); DENNIS L. MERRILL, Grimes, IA (US)

Correspondence Address: MCKEE, VOORHEES & SEASE, P.L.C., 801 GRAND AVENUE, SUITE 3200, DES MOINES, IA, 50309-2721, US

(73) Assignee: MARGARET PLATT BORGEN, Des Moines, IA (US)

(21) Appl. No.: 11/763,486

(22) Filed: Jun. 15, 2007

(51) Int. Cl. B65H 29/24; B65G 57/02; B65G 57/16

(52) U.S. Cl. 414/792.8; 414/792.9; 414/793; 83/277

(57) ABSTRACT

A material moving device is beneficial for manufacturing. The material moving device has a tower assembly, a vertical trolley assembly adapted to travel up and down the tower assembly, a horizontal trolley assembly adapted to travel back and forth along the vertical trolley assembly, and a material pickup assembly connected to the horizontal trolley assembly. The trolleys are adapted to move the material pickup assembly relative to the tower assembly to thereby move materials for manufacturing on to and off of a work surface. A method for moving sheet materials for manufacturing is also beneficial by joining one or more trolley assemblies to each other and to a tower assembly, moving one trolley assembly with the other trolley assembly relative to the tower assembly, attaching a material pickup assembly to one of the trolley assemblies, retrieving sheet materials from within one or more of vertically-stacked shelves with the material pickup assembly, and reposition the sheet material onto a work surface for manufacturing.

### FIELD OF THE INVENTION

The present invention relates to a material moving device and method. In particular, the present invention relates to a material moving device that is economical to construct and operate, occupies little floor space and makes it possible to quickly and efficiently retrieve work materials from storage shelves or a work surface.

### BACKGROUND OF THE INVENTION

The ability to streamline manufacturing, reduce cost and overhead, maximize use of manufacturing floor space, and minimize the downtime of manufacturing machinery are all critical elements in successfully operating a manufacturing business. Currently, many devices exist for moving work materials onto and off of a work surface. These systems range from devices capable of moving material from a single stack and/or several shelves. These systems are typically very large and require a lot of floor space within a manufacturing facility. These systems are often also very costly and contribute to the operating overhead for manufacturing. Also, due to their complexity and the amount of floor space they require to operate, these systems are often difficult to manually load with work materials. These systems also are often specifically dedicated to a single machine for performing some manufacturing process having a work surface and, because of their complexity and size, are not reconfigurable to load and unload work materials from the work surface of other separate manufacturing processes. Therefore, there is a need to provide a material moving device that requires little floor space to operate, is relatively inexpensive and economical, is easy to load, and is configurable to move material from a variety of storage positions onto a work surface associated with a broad gamut of manufacturing processes.

One material moving system entails moving manufacturing materials in sheet form from a storage point onto a work surface. One example where work materials used in a manufacturing process are moved from a stowed position onto a work surface is demonstrated by a system adapted to retrieve a top sheet of work materials from a stack of sheets to thereby transport from a storage point to a work surface associated with a metal cutting machine, such as an automated laser cutter. In many instances, the sheet material is a single stack of sheets positioned near the work surface. In other instances, the sheet material is stacked on several shelves near the system used to move the sheets of material from the shelves onto the work surface. Whether the sheet material is stored on a single stack or several shelves, the current systems used to move the material from the stack or shelves is often very limited in movement. The operating design of the system is often specifically configured based on the amount of material, the different sizes of material, and the way the material is stored. These systems also often over-occupy precious floor space within a manufacturing plant due to the sheer size. Therefore, there is a need to provide a sheet material moving device that requires little floor space and is capable of retrieving sheets of material from a single or multiple stack of sheets and/or varied-size sheets positioned on vertical shelving to thereby maximize the use of floor space within the manufacturing facility.

Positioning manufacturing materials nearest the manufacturing process helps to increase the efficiency of a manufacturing plant, the machine and the time material is spent in transition from storage to the work surface. One of the ways of positioning manufacturing materials closest to the work process and maximizing floor space within the manufacturing facility is to utilize the vertical real estate within the manufacturing facility by positioning the manufacturing materials on vertical shelves adjacent the machine used to perform some manufacturing process on the work materials. Due to the weight of the material sheets, the vertical shelves must have the requisite structure to support such weight. Cantilever shelving offering a series of laterally stacked shelves is one example of a type of shelving that utilizes vertical real estate and can be positioned adjacent the machine and offers the requisite structure to support stacks of metal sheeting on the shelves. Therefore, there is a need to provide a material moving device adapted to retrieve sheets of material from a series of laterally-stacked, cantilevered shelves for positioning onto a work surface associated with a manufacturing process.

Another example of a disadvantage of the present material moving systems is that they restrict access to the work surface making it difficult to otherwise manually inspect, load, and/or unload material from the work surface. Therefore, there is a need to provide a material moving device that does not restrict access to the machine or a work surface associated with the machine or manufacturing process to thereby allow manual as well as automated material inspection and moving.

### BRIEF SUMMARY OF THE INVENTION

Therefore, it is a primary object, feature, or advantage of the present invention to improve over the state of the art for moving devices.

It is a further object, feature, or advantage of the present invention to provide a material moving device that is economical to construct, capable of operating manually or automatically, and requires little floor space within a manufacturing facility.

Yet another object, feature, or advantage of the present invention is to provide a material moving device adapted to operate a horizontal trolley relative to a vertical trolley adapted to travel vertically about a tower.

A further object, feature, or advantage of the present advantage is to provide a material moving device for retrieving a single sheet of material from any one of a series of vertically-stacked, cantilevered shelves.

Yet another object, feature, or advantage of the present invention is to provide a material moving device that does not restrict or limit physical and/or manual access to the work table assembly or material processing assembly.

A further object, feature, or advantage of the present invention is to provide a material moving device having a sheet separator assembly to insure that a single sheet is retrieved off the stack of sheets of material.

A still further object, feature, or advantage of the present invention is to provide a material moving device for retrieving manufactured materials from the work surface.

One or more of these and/or other objects, features, or advantages of the present invention will become apparent from the specification and claims that follow.

According to one aspect of the present invention, a material moving device is disclosed. The material moving device has a tower assembly, a vertical trolley assembly adapted to travel up and down the tower assembly, a horizontal trolley assembly adapted to travel back and forth along the vertical trolley assembly, and a material pickup assembly connected to the horizontal trolley assembly. The trolleys are adapted to move the material pickup assembly relative to the tower assembly to thereby move materials for manufacturing on to and off of a work surface. In the preferred form, a material moving device has one or more vertically-stacked cantilevered shelves adapted to store a sheet material and positioned relative to the material moving device to thereby allow manual access to the work surface and the shelves. The material moving device also has a material pickup assembly having a material separator assembly for urging materials apart to thereby move from a stack. The material moving device also has a laser cutting machine associated with work surface for manufacturing parts from sheet materials.

Another material moving device is disclosed. This device includes a tower assembly, vertical trolley assembly adapted to travel up and down the tower assembly, a horizontal trolley assembly adapted to travel back and forth along the vertical trolley assembly, a material pickup assembly connected to the horizontal trolley assembly, and one or more vertically-stacked cantilevered shelves adapted to store a sheet material by the work surface. The trolleys are adapted to move material from the shelves onto the work surface for manufacturing. In the preferred form, the material pickup assembly has a material separator assembly for urging the sheet material apart. The device also has a laser cutting machine associated with the work surface for manufacturing parts from the sheet material.

A new method for using a material moving device is disclosed. The method includes providing a tower assembly having a vertical trolley assembly and a horizontal trolley assembly with a material pickup assembly, moving the trolley assemblies relative to each other in the tower, retrieving a sheet material from off a plurality of vertically-stacked cantilevered shelves, and repositioning the sheet material onto a work surface for manufacturing. In a preferred form, the method also includes engaging a sheet separator on the material pickup assembly for separating adjacent sheet material and placing the sheet material onto the work surface of a laser cutting machine.

### BRIEF DESCRIPTION OF THE DRAWINGS

While the specification concludes with claims particularly pointing out and distinctly claiming the invention, it is believed that the present invention will be better understood from the following description taken in conjunction with the accompanying drawings in which:

FIG. 1 is an isometric view of the material moving device d according to an exemplary embodiment of the present invention.

FIG. 2 is a top view of the material moving device shown in FIG. 1.

FIG. 3 is an isometric view of the tower according to an exemplary embodiment of the present invention.

FIG. 4 is an enlarged plan view of the tower taken along line 4-4 in FIG. 2.

FIG. 5 is an enlarged view of the controls assembly taken along line 5-5 in FIG. 4.

FIG. 6 is an isometric view of the vertical trolley assembly according to an exemplary embodiment of the present invention.

FIG. 7 is a side view of the vertical trolley assembly shown in FIG. 6.

FIG. 8 is an isometric view of the horizontal trolley assembly according to an exemplary embodiment of the present invention.

FIG. 9 is a side view of the horizontal trolley assembly shown in FIG. 8.

FIG. 10 is an isometric view of the material pickup assembly according to an exemplary embodiment of the present invention.

FIG. 11A is a side view of the material pickup assembly shown in FIG. 10.

FIG. 11B is an enlarged view of the material pickup assembly taken along line 11B-11B in FIG. 10.

FIG. 12 is an operational view of the material moving device and vertically-stacked shelving assembly according to an exemplary embodiment of the present invention.

FIG. 13 is another operational view of the material moving device, vertically stacked shelving assembly, work table assembly and a material processing assembly according to an exemplary embodiment of the present invention.

### DETAILED DESCRIPTION OF THE PREFERRED EMBODIMENT

The present invention includes a number of aspects, all of which have broad and far-reaching application. One aspect of the present invention relates to a material moving device that is economical to construct, capable of operating manually or automatically, and requires little floor space within a manufacturing facility to operate. Another aspect of the present invention relates to a material moving device adapted to retrieve a single sheet of material from any one of a series of vertical-stacked cantilevered shelves. Another aspect of the present invention relates to a material moving device that does not restrict or limit physical and/or manual access to the work table assembly or material processing assembly. Still another aspect of the present invention relates to a material moving device adapted to operate a horizontal trolley relative to a vertical trolley adapted to travel vertically about a tower. Although specific embodiments are described here, the present invention is not to be limited to the specific embodiments. The present invention contemplates numerous other options in the design and use of the material moving device.

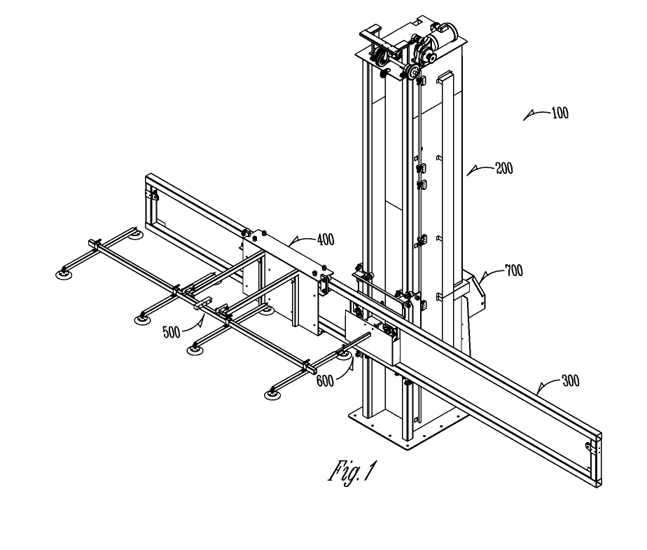

FIG. 1 is an isometric view of the material moving device according to an exemplary embodiment of the present invention. Several assemblies make up the material moving device 100, namely: tower assembly 200, control assembly 700, vertical trolley assembly 300, horizontal trolley assembly 400, material pickup assembly 500, and material separation assembly 600. The tower assembly 200 is the central supporting member of the material moving device 100. The tower assembly 200 is substantially vertical disposed such that it requires a relatively small footprint or manufacturing floor space to install. Movement of vertical trolley assembly 300 is relative to the tower assembly 200. The vertical trolley assembly 300 travels along and is supported by the tower assembly 200. The vertical trolley assembly 300 is moved in position relative to the tower assembly 200. The horizontal trolley assembly 400 is supported by and moves relative to the vertical trolley assembly 300. Material pickup assembly 500 is attached to the horizontal trolley assembly 400 and moves with the horizontal trolley assembly 400 relative to the vertical trolley assembly 300. The material pickup assembly 500 includes a material separation assembly 600.

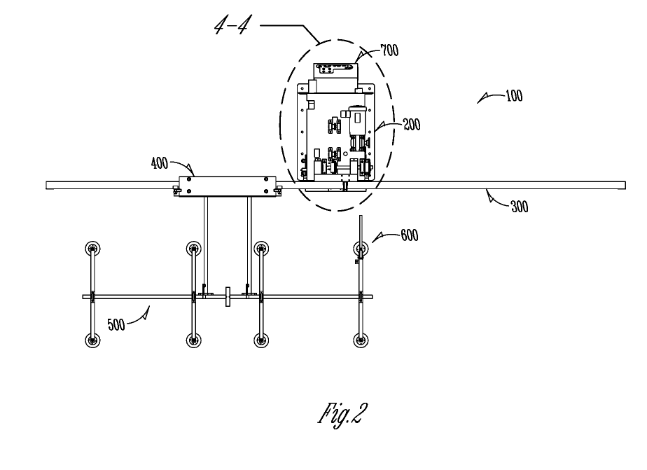

FIG. 2 shows a top view of these same assemblies of the material moving device 100 according to an exemplary embodiment of the present invention.

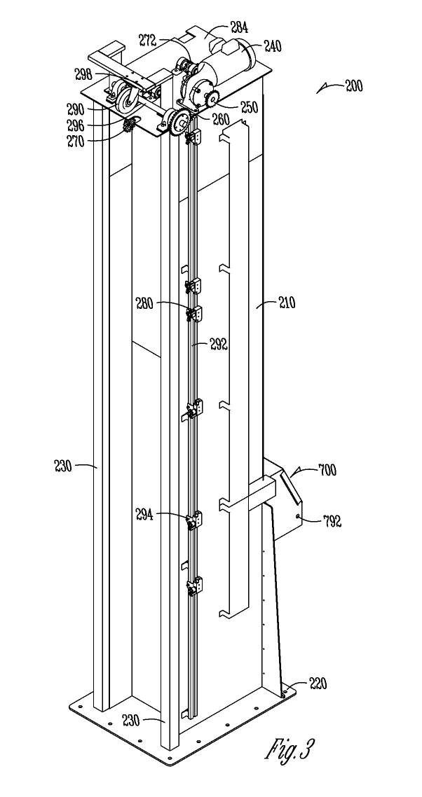

FIG. 3 shows a more detailed isometric view of the tower assembly 200, which includes the controls assembly 700. The tower assembly 200 includes a tower 210. The tower 210 can be constructed of any material capable of withstanding the loads experienced during operation of the material moving device 100. The tower assembly 200 could also be constructed of a single piece or several sections attached together to form a substantially, vertically disposed support member. The tower assembly may be reinforced by ribs or gussets to increase the strength of the tower 210 as would be appreciated by one skilled in the art. A mounting plate 220 is included at the bottom end of the tower 210 for attaching the tower assembly 200 to a floor or some other work surface capable of bearing the weight from the load supported by the tower assembly 200. Positioned on the tower 210, spaced apart and parallel of each other and vertical along the length of the tower 210 is a pair of rails 230. Each rail 230 is attached to and supported by the tower 210. Each rail 230 runs the vertical length of the tower 210 from the mounting plate 220 to cap plate 284 on tower 210 where motor 240 is attached. Motor 240 can be hydraulically, electrically or pneumatically driven. Drive gear 250 is attached to the motor 240. Drive gear 250 can be any type of gear, sprocket or pulley adapted to transfer rotational movement to another radial member. Spaced apart within the same vertical plane from drive gear 250 is a driven gear 260. Rotational movement of the drive gear 250 by the motor 240 is transferred from the drive gear 250 to the driven gear 260 by a chain or cogged belt (not shown).

FIG. 4 better illustrates the alignment of the drive gear 250 with respect to the driven gear 260. The driven gear 260 is attached to shaft 296. Shaft 296 is adapted to rotate with the movement of driven gear 260. Shaft 296 is rotatably supported by bearings 282. Also positioned on the shaft 296 is drive sprocket 298. Positioned in the same vertical plane and rotatably supported by bearings 282 are sprockets 272. Both sprockets 272 are secured to the cap plate 284. Positioned in the same vertical plane as drive sprocket 298 is idler sprocket 270 as best illustrated in FIG. 3. Idler sprocket 270, drive sprocket 298, and sprockets 272 are positioned such that a chain or cog belt (not shown) may be meshed with each of the sprockets such that rotation of the drive sprocket 298 causes movement of the chain or cogged belt (not shown).

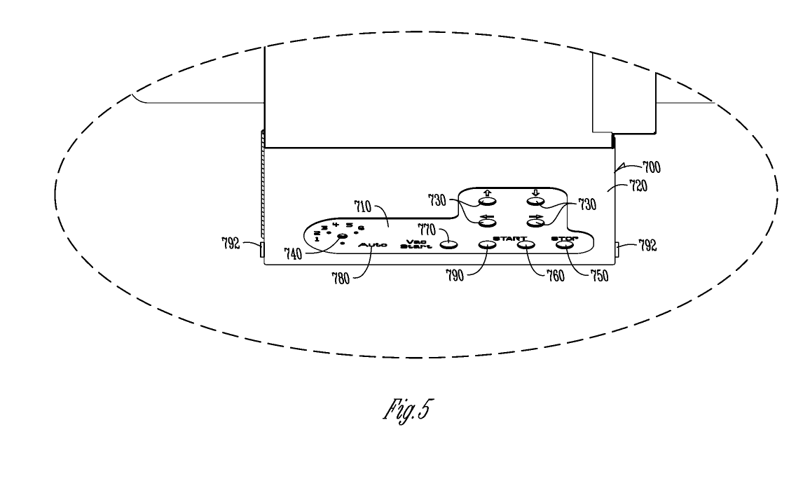

One end of the chain or cog belt (not shown) may be connected to chain connection 380 shown in FIG. 6 and an opposite end may be connected to a counter weight (not shown) to thereby help balance the forces on each end of the chain or cog belt (not shown). Such counter weight may be positioned within the tower 210 whereby movement of the counter weight (not shown) is sealed within the tower 210 for safety reasons, such as to prevent the counter weight (not shown) from descending upon and smashing or severely injuring the hand or other part of an operator operating the material moving device 100. Using the series of sprockets 272, drive sprocket 298 and idler sprocket 270, a chain or cog belt (not shown) may be interwoven between the sprockets so as to encourage meshing between the chain or cog belt (not shown) with a substantial number of teeth on each of the sprockets. For example, a chain or cog belt (not shown) may be configured to pass over the top side of the first sprocket 272 near motor 240, on the underside of sprocket 272 near drive sprocket 298, and over the top portion of drive sprocket 298 on shaft 296, and along the back portion of idler sprocket 270 (shown in FIG. 3) to facilitate meshing between the chain or cog belt (not shown) and the sprockets. Also mounted on top the cap plate 284 is pulley 290. Pulley 290 is configured to rotatably support movement of a power cable (not shown) adjacent the tower 210 and electrically connected with a motor (not shown) of the vertical trolley assembly 300 (shown in FIG. 6). To control the position of the vertical trolley assembly 300 (shown in FIG. 6) a plurality of level switches 280 are mounted along mounting rail 292 with slidably adjustable mounting brackets 294. Level switches 280 relay information about the position of the vertical trolley assembly 300 (shown in FIG. 6) relative to the tower 210 to the controls assembly 700.

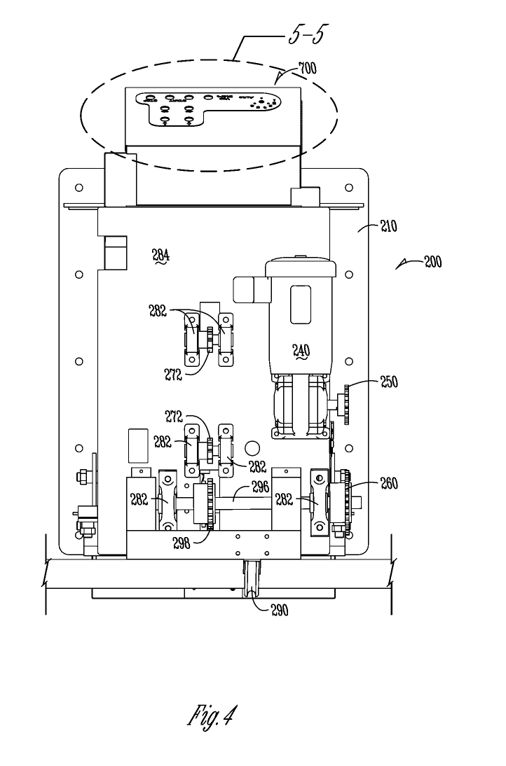

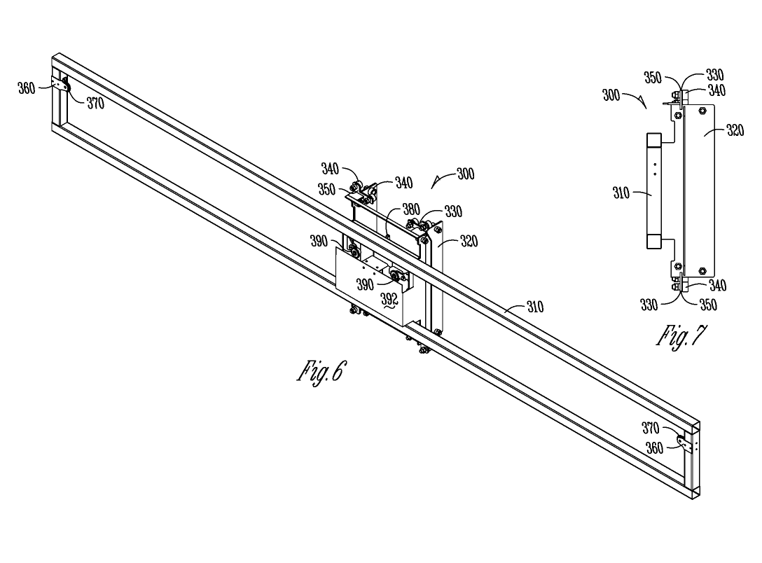

The controls assembly 700 attached to the tower assembly 200 is best illustrated in FIG. 5. The controls assembly 700 has a casing 720 for supporting the control panel 710. The control panel 710, according to an exemplary embodiment of the present invention, has directional movement buttons 730 for moving the vertical trolley assembly 300 (shown in FIG. 6) and the horizontal trolley assembly 400 (shown in FIG. 8). The control panel 710 may also be configured with a level select switch 740, emergency stops button 750, an on/off indicator light 760, on/off switch 790 and a vacuum start button 770. The control panel 710 may also be configured to have vacuum off buttons 792 positioned on opposite sides of the casing 720. The control panel 710 may also be configured to have automatic controls 780. The different controls and features of the controls assembly 700 are introduced here, however, the function of each will be described in the proceeding description of the operation of the material moving device 100.

FIG. 7 illustrates an isometric and side view of the vertical trolley assembly 300. The vertical trolley assembly 300 has a rack 310 attached to rail mount frame 320. The rack 310 has parallel spaced rails extending longitudinally attached at their ends by two upright rail sections. The rack 310 is attached to the rail mount frame 320 so that it moves in concert with the rail mount frame 320. Rail trolleys 330 are mounted to the rail mount frame 320 and have wheels 340 spaced apart on trolley bracket 350 adapted to travel along rail 230 of the tower assembly 200 (shown in FIG. 3). Additionally, one or more wheels 340 may also be mounted to rail mount frame 320 opposite and perpendicular to trolley bracket 350 for securably guiding rail mount frame 320 along rail 230 of the tower assembly 200 in FIG. 3. The combination of the wheels 340 mounted on the trolley bracket 350 and one or more additional wheels 340 mounted on the rail mount frame 320 operate to secure the rail mount frame 320 to the rail 230 of the tower assembly 200 shown in FIG. 3. Also attached to the rail mount frame 320 is chain connection 380, which has been previously described.

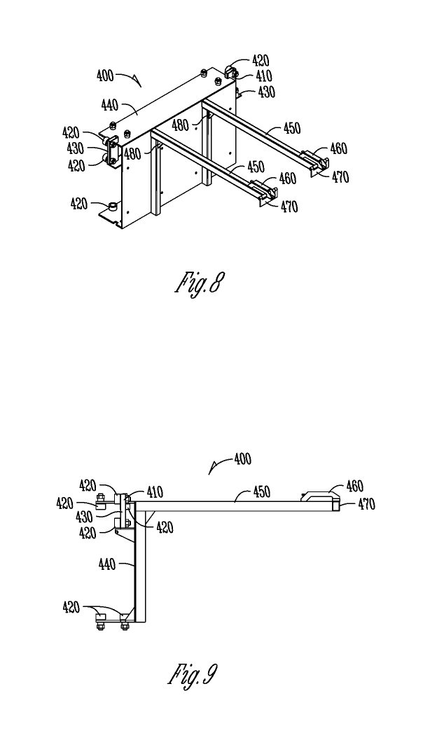

The rail mount frame 320 may house all of the components, structure and motor behind cover plate 392 for moving the horizontal trolley assembly 400 (shown in FIGS. 8 and 9) along the rack 310. For example, mounted on the inside of each side of the rail mount frame 320 is an idler sprocket 390. Also mounted in the same horizontal plane and to the vertical upright sections of the rack 310 is a sprocket bracket 360 for rotatably holding sprocket 370. Below the pair of idler sprockets 390 and behind the cover plate 392 mounted to the rail mount frame 320 is a motor (not shown). In an exemplary embodiment of the present invention, the motor (not shown) may be pneumatically, hydraulically, or electrically driven for turning a sprocket for driving a chain or a cog belt (not shown). For example, a chain or cog belt (not shown) may run the length of the rack 310 between each sprocket 370 such that the chain or cog belt (not shown) meshes with each sprocket 370 and travels back towards the center of rack 310 positioned over top of each idler sprocket 390 and looped down and under, and contact in meshing with a sprocket on the motor (not shown) for rotating the chain or cog belt (not shown). Thus, in an exemplary embodiment of the present invention, the chain or cog belt (not shown) would be operably attached at one or more points to the horizontal trolley assembly 400 (shown in FIGS. 8 and 9) such that as the chain or cog belt (not shown) is rotated in one direction, the horizontal trolley assembly 400 is moved in one direction, and conversely, when the chain or cog belt (not shown) is rotated in an opposite direction the horizontal trolley assembly 400 is moved in an opposite direction along the rack 310. This may be accomplished by connecting the chain or cog belt (not shown) between sprockets 370, over top idler sprockets 390 and under a gear (not shown) of the motor (not shown) to thereby form a continuous loop with the chain or cog belt (not shown).

FIGS. 8 and 9 illustrate isometric and side views respectively of the horizontal trolley assembly 400. The horizontal trolley assembly 400 has a rack mount frame 440. Rack trolleys 410 are mounted to the rack mount frame 440. Each rack trolley 410 has wheels 420 rotatably attached and spaced apart on trolley bracket 430 such that the wheels 420 ride along the top and bottom side of the top and bottom parallel rails (formed by square tubing in one exemplary embodiment) of the rack 310 of the vertical trolley assembly 300. Additionally, one or more wheels 420 may be mounted to the bottom of the rack mount frame 440 to guidably travel along the lower horizontal rail of the rack 310 of the vertical trolley assembly 300 (shown in FIGS. 6 and 7). Other wheels 420 may also be attached to the rack mount frame 440 to secure the horizontal trolley assembly 400 to the rack 310 of the vertical trolley assembly 300 (shown in FIGS. 6 and 7). For example, wheel 420 may be attached to the rack mount frame 440 opposite and perpendicular to the trolley bracket 430 to secure to one of the horizontal rails of the rack 310 (shown in FIG. 6) between each wheel 420 on the trolley bracket 430 and wheels 420 opposite and perpendicular to the trolley bracket 430. For example, in the exemplary embodiment of the present invention, wheels 420 could be spaced apart and rotatably attached to trolley bracket 430 for guidably traveling along the top and bottom side of each rail of the rack 310 (shown in FIG. 6). Another set of wheels 420 could be spaced apart and rotatably attached to the rack mount frame 440 for guidably traveling along the front and back of one of the horizontal rails of the rack 310 (shown in FIG. 6). In the preferred embodiment, the wheels 420 are spaced apart and rotatably attached in tandem for guidably traveling along a portion of each horizontal rail of the rack 310 (shown in FIG. 6). However, it is also appreciated that in some instances a single wheel 420 with other guide members would provide the necessary support for supportably guiding the horizontal trolley assembly 400 along the rack 310 shown in FIG. 6.

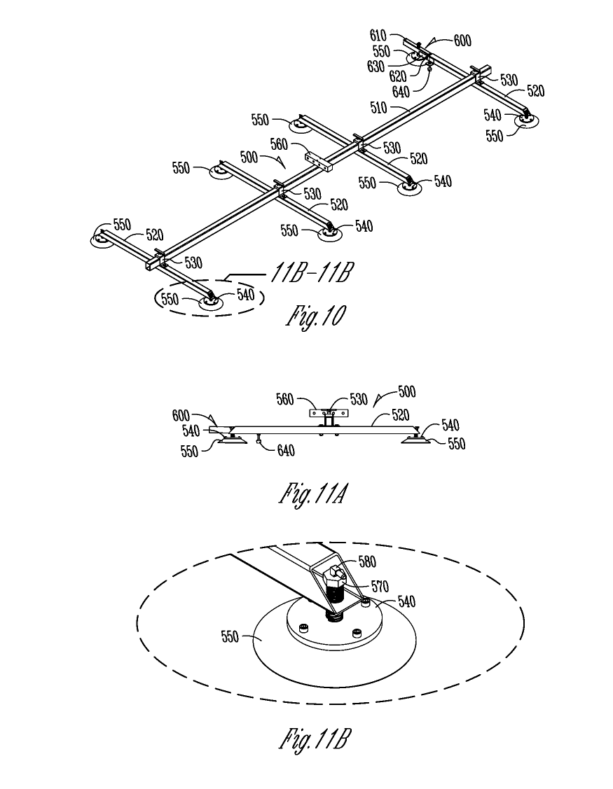

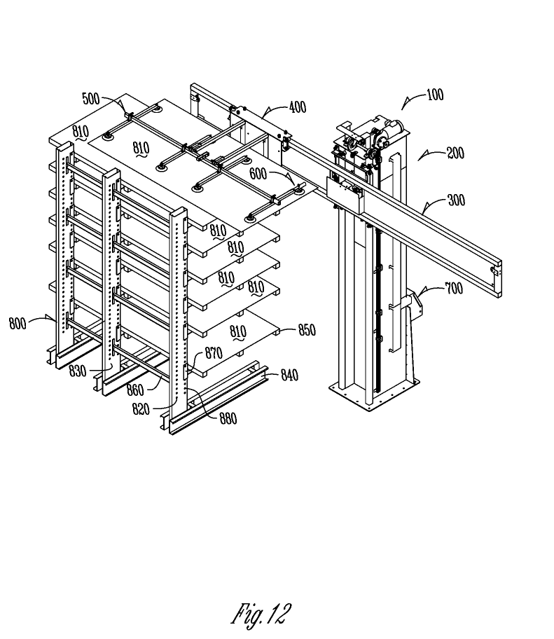

Also mounted to rack mount frame 440 are mounting arms 450. The mounting arms 450 each form an L-shape and may be welded, bolted, riveted or screwed to the rack mount frame 440. The mounting arm 450 may be reinforced with gussets or reinforcement ribs 480. It can be appreciated that a pair of mounting arms 450 may be spaced apart parallel to each other and mounted to the rack frame 440 or alternatively, several mounting arms 450 may be attached to the rack mount frame 440. Positioned on one end of each mounting arm 450 opposite the rack mount frame 440 is a mounting hinge 470. Each mounting hinge 470 is rotatable and is adapted to be attached to the material pickup assembly 500 shown in FIG. 10. The mounting hinge 470 may be attached to the material pickup assembly 500 by way of a screw, weld, rivet, bolt or some other connection means. Positioned on the top and at each end opposite the rack mount frame 440 of each mounting arm 450 is a stop bracket 460. The stop bracket 460 is adapted to restrict rotation of each mounting hinge 470 and may be adjusted to permit rotation of each mounting hinge 470 to thereby change the angle of the material pickup assembly 500 relative to a horizontal plane. For example, the stop bracket 460 may be adjusted so that each mounting hinge 470 is permitted to rotate to a specified angle to change the pitch or attitude at which the material pickup assembly 500 (shown in FIGS. 10 and 11A) is suspended from the horizontal trolley assembly 400. The advantages of allowing the material pickup assembly 500 shown in FIG. 10 to be suspended from the horizontal trolley assembly 400 at a specific angle will be described further on in the description of the operation of the material moving device 100.

FIGS. 10, 11A and 11B best illustrate the material pickup assembly 500 and material separation assembly 600. Addressing the material pickup assembly 500 first, the material pickup assembly 500 has a central support arm 510. Adjustably mounted to the central support arm 510 is a plurality of lift arms 520. The lift arms 520 are mounted perpendicular to the central support arm 510 so that the plurality of lift arms 520 extend away from the central support arm 510 in parallel planes. Each lift arm 520 is adjustably attached to the central support arm 510 with mounting bracket 530. In one exemplary embodiment of the present invention, set screws with a handle for gripping are positioned through each mounting bracket 530 to adjustably secure the mounting bracket 530 of each lift arm 520 to the central support arm 510. It can be appreciated that by adjustably mounting each lift arm 520 to the central support arm 510, the lift arms 520 may be adjusted in position along the length of the central support arm 510 to lift materials of varying length and weight. In the preferred embodiment of the present invention, the central support arm 510 and lift arm 520 may be constructed of square tubing. However, other materials may be well suited as a central support arm 510 or lift arm 520 such as channeled tubing or pipe.

Attached at each end of each lift arm 520 by way of a connection member 570 is a suction member 550, as best illustrated in FIG. 11B. The suction member 550 is attached to a mounting member 540 being connected to connection member 570. Suction member 550 is a pliable ring made of such materials as plastic, rubber or the like, capable of sealingly engaging and gripping a planar or flat surface material. The suction member 550 is preferably vacuum activated. To provide a vacuum force at each suction member 550, a vacuum motor (not shown) is connected to the vacuum manifold 560 mounted on the central support arm 510 which transfers a vacuum pressure through vacuum tubing (not shown) from the vacuum manifold 560 through vacuum fitting 580, connection member 570 and mounting member 540 into suction member 550. The vacuum motor (not shown) for operating each suction member 550 may be positioned on the material pickup assembly 500, horizontal trolley assembly 400, vertical trolley assembly 300 or tower assembly 200. The electrical requirement of the vacuum motor (not shown) may be provided through electrical cords running from the tower assembly 200 to wherever the vacuum motor (not shown) is positioned for operating each suction member 550 of the material pickup assembly 500.

Also positioned on the material pickup assembly 500 is a material separation assembly 600. The material separation assembly 600 has a breaker arm 610 pivotally attached to an end of one of the lift arms 520. A suction member 550 is attached to the breaker arm 610 and moves with the breaker arm 610. The breaker arm 610 is attached to the lift arm 520 by fitting 620. The fitting 620 may be a pin or bearing adapted to allow the connected breaker arm 610 to rotate or pivot with respect to the lift arm 520. The pivoting motion of the breaker arm 610 may be affected manually or automatically. For example, an operator may manually lift up on the end of the breaker arm 610 to pivot the breaker arm 610 about the fitting 620. Alternatively, the breaker arm 610 may be mechanically articulated about the fitting 620 using a pneumatically, hydraulically or electrically driven actuator (not shown). In one exemplary embodiment of the present invention, the breaker arm 610 may be actuated using vacuum pressure from vacuum manifold 560. Positioned adjacent the breaker arm 610 and attached to the lift arm 520 is a sensor 640. The sensor 640 may be configured to indicate when the sensor 640 comes into contact with a planar or sheet-like material. Additionally, the sensor 640 may be configured to monitor the angle at which the breaker arm 610 is pivoted about the fitting 620. The material separation assembly 600, in the preferred embodiment of the present invention, helps to initiate separation of a top sheet-like material from an underlying sheet. It can be appreciated that one or more material separation assemblies may be configured on lift arms 520 if necessary to better facilitate separation of the materials being lifted by the material pickup assembly 500. It may also be appreciated that alternative type material separation assemblies may be used to help facilitate separation of sheet-like materials being lifted by the material pickup assembly 500. For example, using air from the vacuum motor (not shown) and connecting to the vacuum manifold 560, a material separation assembly could be configured on the end of one or more of the lift arms 520 to inject high pressured air between the sheet-like material as the breaker arm 610 is actuated and lifts up on a corner of the sheet to thereby encourage separation of the top sheet from the underlying sheet.

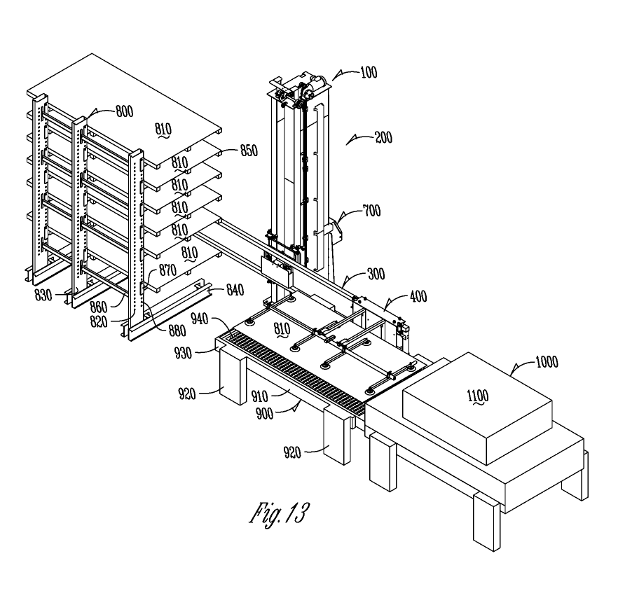

FIG. 12 shows the material moving device 100 retrieving sheet material 810 from off of vertically-stacked shelving assembly 800. Vertically-stacked shelving assembly 800 is one example of a type of shelving commonly used for storing materials using vertical space as opposed to horizontal space. Similar to the vertical tower assembly 200, the vertically-stacked shelving assembly 800 occupies substantially more vertical space in a manufacturing plant or facility than floor space so as to use as little floor space as possible. The vertically-stacked shelving assembly 800 has a series of laterally and vertically stacked shelving 820. The shelving consists of a plurality of upright members 830 attached to a base member 840. Cantilevered shelves 850 attached to the upright member 830 extend laterally outward from the upright member 830 for supporting sheet material 810 thereon. Brace members 860 may be positioned between upright members 830 for additional support. Each of the cantilevered shelves 850 attaches to the upright member 830 by way of mounting plate 870. The mounting plate 870 is adjustable along the height of each upright member 830 using mounting holes 880. The vertically-stacked shelving assembly 800 is adjustable to store various types, quantities and sizes of sheet material 810. For example, the cantilevered shelves 850 may be positioned relatively close to each other so that a numerous number of various types of sheet material 810 may be stored on each cantilever shelf 850. Furthermore, because the material pickup assembly 500 requires very little distance between sheet materials 810 stacked on cantilevered shelves 850, the material pickup assembly 500 is capable of retrieving sheet material 810 from cantilevered shelves 850 even when the cantilevered shelves 850 are positioned relatively close to each other along upright member 830. In fact, the material pickup assembly 500 requires a gap of only the height of the material pickup assembly 500 to move between cantilevered shelves 850 to retrieve sheet material 810 from the vertically-stacked shelving assembly 800. This design allows a manufacturer the flexibility of storing multiple types of work materials 810 on a single vertically-stacked shelving assembly 800 to thereby maximize use of vertical space and minimize the use of floor space within a manufacturing plant or facility.

Using the illustration in FIG. 5 along with the illustrations in FIGS. 12 and 13, operation of the material moving device 100 is further explained. Using the control panel 710 an operator may manually or automatically retrieve sheet material 810 from off of any one of the cantilevered shelves 850. To manually retrieve sheet material 810 from off of cantilevered shelves 850 the operator actives the material moving device 100 using on/off switch 790. Once activated, on/off indicator light 760 may also indicate that the material moving device 100 has been activated and is ready for operation. Directional movement buttons 730 allow the operator to move the material device up, down, left and right as illustrated by the arrows. To move the material pickup assembly 500 up or down to the desired cantilevered shelves 850, the operator presses one of the up or down directional movement buttons 730. The motor 240 is activated and moves a chain or cog belt (not shown) attached to the vertical trolley assembly 300 at chain connection 380 to thereby move the vertical trolley assembly 300 up or down along the rails 230 of the tower 210. Once the operator has positioned the material pickup assembly 500 in the proper vertical position by moving the vertical trolley assembly 300, the operator then may use the left or right directional movement buttons 730 on the control panel 710 to move the horizontal trolley assembly 400 into or on top of one of cantilevered shelves 850 to retrieve sheet material 810. To do this, the operator pushes either the left or the right button of the directional movement buttons 730 which engage the motor (not shown) on the vertical trolley assembly 300 to turn chain or cog belt (not shown) attached to the horizontal trolley assembly 400 to thereby move the horizontal trolley assembly 400 back and forth along the rack 310 of the vertical trolley assembly 300. Once the operator has positioned the material pickup assembly 500 over top of the desired sheet material 810, the operator may move the vertical trolley assembly 300 downward using the directional movement buttons 730 so that suction members 550 come into contact with sheet material 810. To grip the sheet material 810 with suction members 550 on the material pickup assembly 500, the operator then may activate the vacuum motor (not shown) using vacuum start button 770 on the control panel 710. Activation of the vacuum start button 770 may also instantaneously or with delay automatically activate the material separation assembly 600 thereby moving the breaker arm 610 to encourage separation of sheet material 810 attached to the material pickup assembly 500 from the underlying sheet. Once the material pickup assembly 500 is attached to the sheet material 810 the operator may then move the vertical trolley assembly 300 upward using the up button of the directional movement buttons 730 on the control panel 710 to thereby separate the sheet material 810 from the underlying sheet. Once sheet material 810 gripped by the material pickup assembly 500 is lifted upward away from the underlying sheet, the operator then may use the left or right buttons of the directional movement buttons 730 on the control panel 710 to move the sheet material 810 out away from the vertically-stacked shelving assembly 800 and onto the work table assembly 900 as shown in FIG. 13. The work table assembly 900 is of the type that is well-known within manufacturing. The work table assembly 900 includes a work table 910 having support legs 920 attached to support frame 930 for engaging and supporting the work surface 940. To accurately position the sheet material 810 on the work surface 940 the operator may adjust each stop bracket 460 so that the material pickup assembly 500 has a slight pitch or angle with respect to the work surface 940. This slight angle or pitch of the material pickup assembly 500 and the sheet material 810 being gripped by the material pickup assembly 500 urges the sheet material 810 to a specific position on the work surface 940 when the sheet material 810 is set down on top of the work surface 940 by operation of the vertical trolley assembly 300. To release the sheet material 810 onto the work surface 940, the operator may activate both vacuum off buttons 792 on the control assembly 700. The vacuum off buttons 792 are positioned opposite each other on the controls assembly 700 to prevent both buttons from accidentally being activated and thereby dropping sheet material 810 from the material pickup assembly 500. Once vacuum off buttons 792 are activated, the vacuum motor (not shown) is shut off and the suction members 550 release grip of the sheet material 810. The sheet material 810 would then be moved into the material processing assembly 1000 where a material cutter 1100 processes the sheet material 810 into parts. In the preferred embodiment of the present invention, the material processing assembly 1000 is a laser cutter for processing sheet material 810 into parts. However, it is well within the spirit and scope of the present invention, for the material processing assembly 1000 to include various and sundry manufacturing processes, such as a welding process, a weld cutting process, an electrical cutter, a housing for sandblasting materials, or any other like process.

As noted earlier, the controls assembly 700 may also be configured to operate automatically. For example, the controls assembly 700 of the present invention could be configured to communicate with and be operated by a PC using software specially designed to perform computer controlled operation of the control panel 710. In one exemplary embodiment of the present invention, the operator could engage the auto feature 780 of the control panel 710 and select the cantilevered shelves 850 using dial 740 that the operator desires to retrieve sheet material 810 therefrom. For example, the operator could select the sixth shelf using dial 740 so that the material moving device 100 retrieves sheet material 810 from the sixth cantilevered shelf 850. Alternatively, the dial shelf select 740 could be configured to operate the material moving device 100 to retrieve sheet material 810 from multiple shelves in various order depending on the type of sheet material 810 desired for the material processing assembly 1000.

The preferred embodiment of the present invention has been set forth in the drawings and specification and although specific terms are employed, these are used in the generically descriptive sense only and are not used for the purposes of limitation. Changes in the formed proportion of parts as well as in the substitution of equivalence are contemplated as circumstances may suggest or are rendered expedient without departing from the spirit and scope of the invention as further defined in the following claims.

What is claimed is:

1. A material moving device, comprising:
a tower assembly;
a vertical trolley assembly adapted to travel up and down the tower assembly;
a horizontal trolley assembly adapted to travel back and forth along the vertical trolley assembly;
a material pickup assembly connected to the horizontal trolley assembly; and
the trollies adapted to move the material pickup assembly relative to the tower assembly to thereby move materials for manufacturing onto and off a work surface.

2. The device of claim 1 further comprises one or more vertically-stacked cantilevered shelves adapted to store a sheet material and positioned relative to the material moving device to thereby allow manual access to the work surface and the shelves.

3. The device of claim 1 wherein the material pickup assembly further comprises a material separator assembly for urging materials apart to thereby move from a stack.

4. The device of claim 1 further comprises a laser cutting machine associated with the work surface for manufacturing parts from sheet materials.

5. The device of claim 1 wherein the horizontal trolley assembly moves vertically together with the vertical trolley assembly.

6. The device of claim 1 wherein the horizontal trolley assembly further comprises a pair of arms adapted to connect the material pickup assembly to the horizontal trolley assembly.

7. The device of claim 1 wherein the pickup assembly further comprises a support member having a plurality of arms with one or more grip members on opposite ends of each arm to thereby pick up work materials.

8. The device of claim 4 wherein the material pickup assembly is adapted to operate under vacuum from a pump.

9. The device of claim 1 wherein the tower assembly further comprises a track for supporting and guiding travel of the vertical trolley assembly.

10. The device of claim 9 wherein the vertical trolley assembly further comprises a track trolley for movement along the track.

11. The device of claim 1 wherein the vertical trolley assembly further comprises a rack having parallel members extending longitudinally outward away from the tower for supporting and guiding travel of the horizontal trolley assembly.

12. The device of claim 11 wherein the horizontal trolley assembly further comprises a track trolley for movement along the parallel members.

13. A material moving device, comprising:
a tower assembly;
a vertical trolley assembly adapted to travel up and down the tower assembly;
a horizontal trolley assembly adapted to travel back and forth along the vertical trolley assembly;
a material pickup assembly connected to the horizontal trolley assembly;
one or more vertically-stacked cantilevered shelves adapted to store a sheet material by a work surface; and
the trollies adapted to move the sheet material from the shelves onto the work surface for manufacturing.

14. The device of claim 13 wherein the material pickup assembly further comprises a material separator assembly for urging the sheet material apart.

15. The device of claim 13 further comprises a laser cutting machine associated with the work surface for manufacturing parts from the sheet material.

16. A method for using a material moving device, comprising:
providing a tower assembly having a vertical trolley assembly and a horizontal trolley assembly with a material pickup assembly;
moving the trolley assemblies relative to each other and the tower;
retrieving a sheet material from off a plurality of vertically-stacked cantilevered shelves; and
repositioning the sheet material onto a work surface for manufacturing.

17. The method of claim 16 further comprising the step of engaging a sheet separator on the material pickup assembly for separating adjacent sheet material.

18. The method of claim 16 further comprising the step of placing the sheet material onto the work surface of a laser cutting machine.

19. A method for using a material moving device, comprising:
joining one or more trolley assemblies to each other and to a tower assembly;
moving one trolley assembly with the other trolley assembly relative to the tower assembly;
attaching a material pickup assembly to one of the trolley assemblies;
retrieving sheet materials from within one or more vertically-stacked cantilevered shelves with the material pickup assembly; and
repositioning the sheet material onto a work surface for manufacturing.

20. The method of claim 19 wherein the sheet material is positioned onto the work surface of a laser cutting machine.
